(19) United States
(12) Patent Application Publication
(10) Pub. No.: US 2018/0189745 A1
(43) Pub. Date: Jul. 5, 2018

(54) SYSTEM, METHOD AND COMPUTER PROGRAM PRODUCT FOR ESTIMATING, SCHEDULING, AND MONITORING FARM ACTIVITY

(71) Applicant: International Business Machines Corporation, Armonk, NY (US)

(72) Inventors: Kala Fleming, Nairobi (KE); Jonathan Lenchner, North Salem, NY (US); Komminist Weldemariam, Nairobi (KE)

(73) Assignee: International Business Machines Corporation

(21) Appl. No.: 15/396,922

(22) Filed: Jan. 3, 2017

(51) Int. Cl. G06Q 10/10; G06Q 10/06

(52) U.S. Cl. CPC G06Q 10/1097; G06Q 10/06316

(57) ABSTRACT

A farm activity control method, system, and computer program product includes generating a list of optimal farming activities including different phases of farming, translating the list of optimal farming activates into a plurality of tasks that are sequenced in an order of operation or according to a time scale, and generating a visual electronic calendar that displays and tracks a completion of the sequenced tasks while providing a notification based on a time and a criticality of each task.

### BACKGROUND

The present invention relates generally to a farm activity control method, and more particularly, but not by way of limitation, to a system, method, and computer program product for estimating or generating farming activities, translating the activities on an electronic timetable with tasks, and notifying the user of the tasks on a device.

Farmers, especially small-scale farm owners, face a common set of challenges that makes farming feel like a perpetual risk due to weather changes, irrigation equipment breaking or becoming unavailable, the vicissitudes of manual labor, etc. The traditional Farmers' Almanac and existing technologies for farmer assistance do not address these risks and the associated consequences of poor productivity and reduced profits.

Conventional techniques for management of a farm consider a static set of activities based on traditional estimating techniques such as using the Farmer's Almanac.

### SUMMARY

In an exemplary embodiment, the present invention can provide a computer-implemented farm activity control method, the method including generating a list of optimal farming activities including different phases of farming, translating the list of optimal farming activities into a plurality of tasks that are sequenced in an order of operation or according to a time scale, and generating a visual electronic calendar that displays and tracks a completion of the sequenced tasks while providing a notification based on a time and a criticality of each task.

One or more other exemplary embodiments include a computer program product and a system.

Other details and embodiments of the invention will be described below, so that the present contribution to the art can be better appreciated. Nonetheless, the invention is not limited in its application to such details, phraseology, terminology, illustrations and/or arrangements set forth in the description or shown in the drawings. Rather, the invention is capable of embodiments in addition to those described and of being practiced and carried out in various ways and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

Aspects of the invention will be better understood from the following detailed description of the exemplary embodiments of the invention with reference to the drawings, in which:

FIG. 1 exemplarily shows a high-level flow chart for a farm activity control method 100;

FIG. 2 exemplarily shows a system layout 200 of the farm activity control method 100;

FIG. 3 depicts a cloud computing node 10 according to an embodiment of the present invention;

FIG. 4 depicts a cloud computing environment according to an embodiment of the present invention; and

FIG. 5 depicts abstraction model layers according to an embodiment of the present invention.

### DETAILED DESCRIPTION

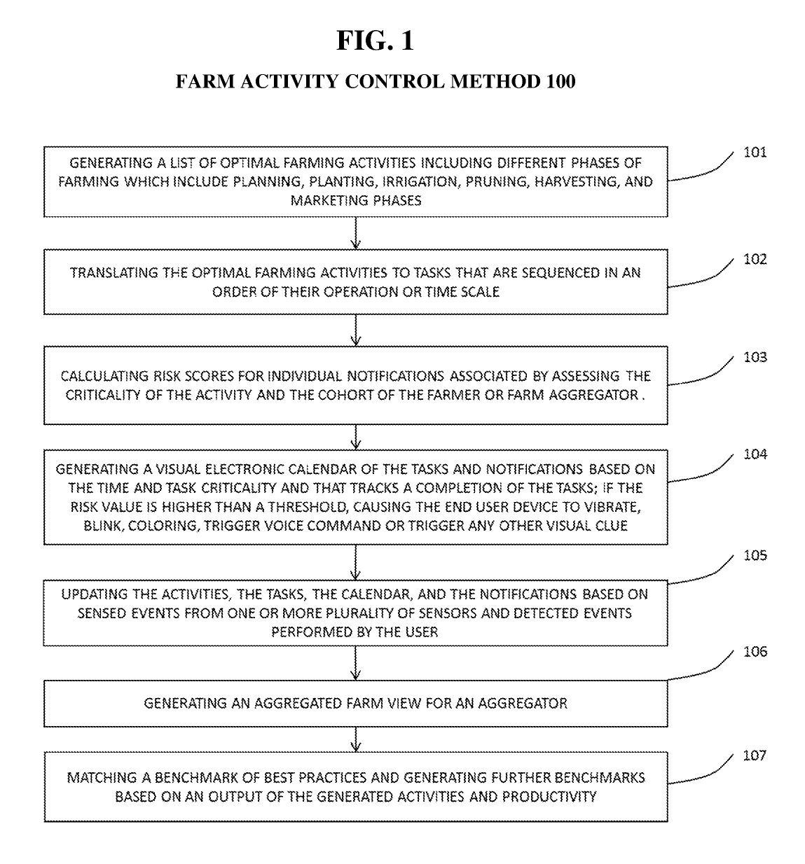

The invention will now be described with reference to FIG. 1-5, in which like reference numerals refer to like parts throughout. It is emphasized that, according to common practice, the various features of the drawings are not necessarily to scale. On the contrary, the dimensions of the various features can be arbitrarily expanded or reduced for clarity.

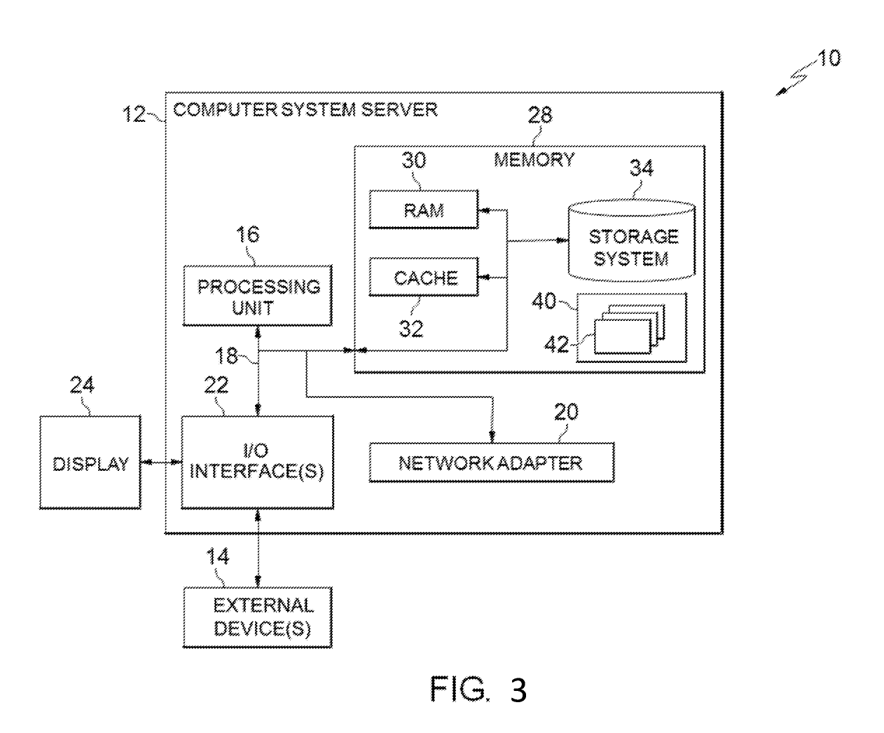

With reference now to the example depicted in FIG. 1, the farm activity control method 100 includes various steps to estimate or generate farming activities, translate the activities on a timetable with tasks, and notify the user of the tasks on a device. As shown in at least FIG. 3, one or more computers of a computer system 12 according to an embodiment of the present invention can include a memory 28 having instructions stored in a storage system to perform the steps of FIG. 1.

Thus, the farm activity control method 100 according to an embodiment of the present invention may act in a more sophisticated, useful and cognitive manner, giving the impression of cognitive mental abilities and processes related to knowledge, attention, memory, judgment and evaluation, reasoning, and advanced computation. A system can be said to be “cognitive” if it possesses macro-scale properties—perception, goal-oriented behavior, learning/memory and action—that characterize systems (i.e., humans) generally recognized as cognitive.

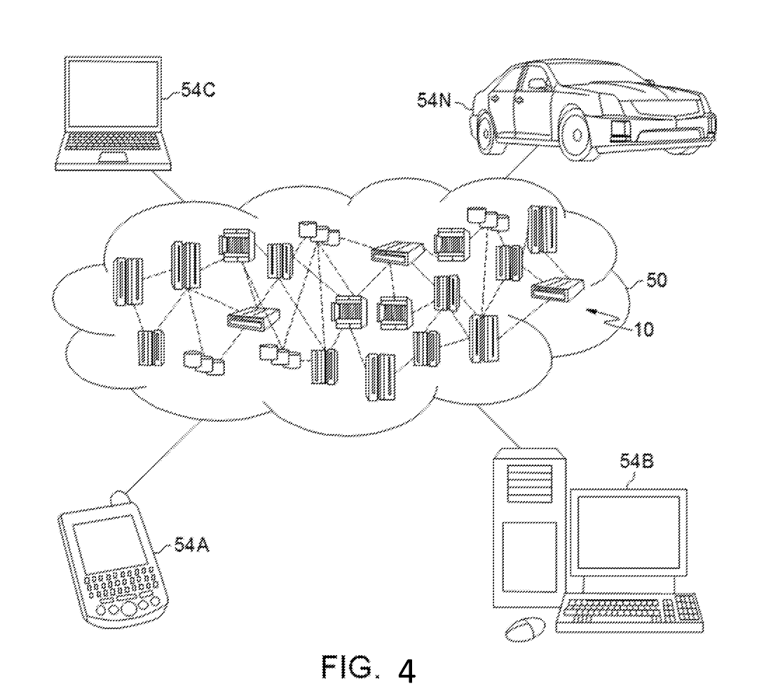

Although one or more embodiments (see e.g., FIGS. 3-5) may be implemented in a cloud environment 50 (see e.g., FIG. 4), it is nonetheless understood that the present invention can be implemented outside of the cloud environment.

In step 101, a list of optimal farm activities are generated or estimated given a crop database, farm history, farmer resources, and cohort analysis. The farm activities are generated or estimated along the different phases of farming, which include planting, planning, irrigation, pruning, harvesting, and marketing phases. The activities in each of the phases are optimized by taking into consideration information such as resources available or affordable to the farmer (e.g., farm equipment, farm inputs, farm employees, etc.), water sources, various sensed events and the associated context (e.g., weather, disease, water levels/availability, market prices, etc.), best practices, farm history (e.g., the types, varieties, frequencies of crops that have been planted in the farm, as well as the types, and frequency of farm inputs that have been used) or crowd-sourced information (such as best practices by other farmers).

In one embodiment, analyzing water points (i.e., an access point (or the like) that can connect a user to a water source and can include the opening to a shallow well, boreholes with pumps and a tap, a standpipe connected to piped water distribution system or a kiosk that consists of a storage tank and water tap, rivers, etc.) may require ground, surface, or aquifer modeling and prediction. The generating or estimating in step 101 can take into consideration longitudinal information such as data obtained from an aquifer or aquifer model, from an historical crop database or disease database, and other contextual or environmental databases and cohorts (e.g., the farm and/or farmer history).

In step 102, the optimal farming activities are translated into tasks that are sequenced into an order of operation, possibly including precise time intervals between tasks. For each farmer, the optimized activities are filtered and translated to tasks that are then sequenced in the order of their operation, possibly incorporating time intervals, and populated on an electronic calendar (as described in step 103 later). Relevant resources may be attached or linked to the task specification on the electronic calendar. For example, an optimal farming activity can include watering certain crops and applying pesticides. In step 102, the watering and applying pesticides is translated into the tasks to perform the activities and when (e.g., the optimal time) to perform each activity. Also, the activities are sequenced for the farmer to follow the instructions.

In step 3, for individual notifications risk scores associated with the not performing the tasks to be carried out by a farmer or farm aggregator are computed wherein the risk scores are determined by assessing the criticality of the activity with respect to the cohort of the farmer or farm aggregator.

In step 104, a visual electronic calendar of the sequenced tasks and notifications associated with the tasks are generated on a device. The notifications are based on the time and the task criticality. Also, the visual electronic calendar is generated such that the completion of the tasks is tracked (e.g., tasks are highlighted, for example, when completed).

The visual electronic calendar may be accessible to the farm on his/her device or community display screen. The farmers can interact with the visual electronic calendar to customize system generated and sequenced tasks with linked resources. The device with which a farmer may interact may include a feature phone, a smartphone, a tablet, a laptop, a raspberry Pi, a smart watch, a community display screen, or any configurable sensors, which may receive messages.

The notifications can include reminding and tracking tasks from the electronic calendar. The notifications can focus on generating a task message, sending the message, receiving an acknowledgement, resending the message if no acknowledgement is received in given time interval, requesting the end user provide information on task accomplishment after or before a given task completion time elapsed (e.g., the end user finished watering a crop), and/or updating the electronic calendar based on task accomplishment, delay or error.

In step 104, the notification may (i) cause the end user device to vibrate, blink, incur some coloring, (ii) trigger a voice command or (iii) trigger any other visual clue if the risk score associated with non-performance of a task is higher than a threshold.

In step 105, the activities, the tasks, the calendar, and the notifications are updated based on sensed events from a plurality of sensors or detected events performed by the user (e.g., updating the sequence if the user performs a task) or based on external activities. For example, external events (e.g., weather, disease patterns, soil moisture levels, water points, market prices, etc.) and user actions are tracked and the activities, tasks, resources, etc. are updated. The electronic calendar can change, and may regenerate notifications automatically.

The electronic calendar may be updated in step 104 based on ongoing activities, context change, or external event detection. This update may trigger a cascading agent that determines the necessary changes on notification and farm monitoring and propagates the changes.

In step 105, the events may be tracked by analyzing any of trending weather, irrigation scheduling for water consumption, market information system, etc., and generating suggested activities based on the results of the analysis and communicating with an activity planner. The existing activities may be updated, or a new activity may be created which are then propagated to the electronic calendar. In some embodiments, events may be detected or traced using a statistical analysis (e.g. Bayesian modeling, etc.), predictive modeling techniques, etc.

At least steps 101-105 enable farmers not to be required to remember tedious tasks by providing an easy and transparent means to monitor farming tasks, and track progress without the need for ad-hoc operations. For example, by tracking the activity of the farmer and updating the calendar, the engagement level of the farmer is measured based on how often the farmer follows up with tasks, takes additional effort to provide information for the system (e.g., leaving comments, taking a picture of a crop or of the farm, recording video of the farm), etc.

This monitoring of farm activities can prove useful for farm aggregators. That is, in step 106, an aggregated farm view for an aggregator can be generated. For example, aggregating farming activities on a dashboard, further allows aggregators to (re)-assign activities (e.g., learning activities based on new farming skills or practices as recommended through cohort analysis) to an individual farmer or a group of farmers using similarity analysis of farming/farmer profile.

Thus, a unified view of farm activities can be provided to an aggregator, to investors or to any relevant actors. A farming-monitoring interface may allow an aggregator to control critical tasks of the farm through a messaging service. Other utilities allow the aggregator to easily update a task or assign activities to a farmer or group of farmers. The aggregator can determine plans for a group of co-located (e.g., small-scale) farmers regarding when to coordinate and share resources (e.g., water, fertilizer, transportation, etc.) and how to differentiate their crop selection so that they avoid harvesting and selling when market prices are low.

In some embodiments, generating the aggregated view includes estimating a crop yield, a value of the crop yield, and a probability of defaulting on any contracts with aggregators.

In step 107, a benchmark of best practices (e.g., the most optimal and cost-effective farming activities) can be matched when translating the farming activities into tasks while generating further benchmarks based on an output of the generated activities and productivity. In other words, past activity that resulted in profits, or healthy crops, can be matched with similar activities to increase yield from the crops.

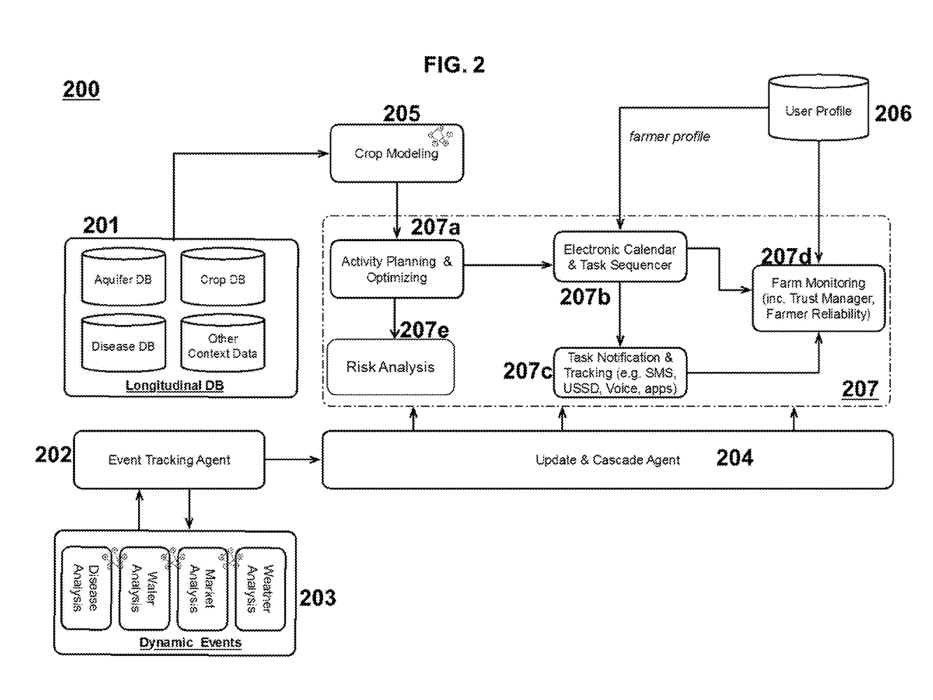

FIG. 2 exemplarily shows a system layout for modules in a cloud-computing environment or software modules on a device to execute the method 100.

The activity planner & optimizing module 207a can generate optimal farming activities along the different phases of farming, which include planning, planting, irrigation, pruning, harvesting, and marketing phases. Activities in each of the phases can be optimized by taking into consideration information of the longitudinal database 201 and how the crops react to the information contained in the database 201 (e.g., via the crop modeling module 205) such as resources available or affordable to the farmer (e.g., farm equipment, farm inputs, farm employees, etc.), water sources, predicted events (e.g., weather, disease, water, market, etc.), best practices, farm history (e.g., the types, varieties, and frequencies of crops which have been planted in the farm, types/frequencies of farm inputs have been used, etc.) or crowd-sourced information (e.g., such as best practices by other farmers). Analyzing water points may include surface water or aquifer modeling and prediction.

The risk analysis module 207e can determine a risk score associated with non-performance of each task scheduled to be carried out by a farmer or farm aggregator by assessing the criticality of the activity and the cohort of the farmer or farm aggregator.

The electronic calendar & task sequencer 207b can, for each farmer (e.g., interacts with a user profile 206), filter and translate the optimized activities to tasks that are sequenced in the order of their operation or time scale, and populated on an electronic calendar. The visual electronic calendar may be accessible to the farmer on his/her own device or community display screen. The farmers can interact with the visual electronic calendar to customize system generated and sequenced tasks with linked resources. Relevant resources may be attached or linked to the task specification on the electronic calendar. The electronic calendar may update itself based on ongoing activities, context change, or external event detection. The update may trigger the update and cascade agent 204 that determines the necessary changes based on notification and farm monitoring and propagates the changes.

The task notification & tracking module 207c can receive information from the electronic calendar & task sequencer 207b to remind and track tasks from the electronic calendar including a focus on generating a task message, sending the message, and receiving acknowledgement. Also, the module 207c can resend the message if no acknowledgement is received in a given time interval, request the end user on task accomplishment after or before a given task completion time has elapsed, update the electronic calendar based on task accomplishment, delay or error, etc. Intelligent localization, metaphor and other contextual analysis techniques may be used to match the farmer profile.

The event tracking agent 202 can detect and track events by analyzing weather trending, irrigation scheduling for water consumption, market information, etc. (e.g., using the dynamic events 203). This may include generating suggested activities based on the results of the analysis and communicating with the activity planner.

The update & cascade agent 204 can be utilized to trigger the activity planning & optimizing module 207a to update existing activities or create a new activity and to propagate the electronic timetable.

The farm-monitoring module 207 can provide a unified view of farm activities to aggregator, investors or to any relevant actors. For example, a monitoring interface can allow an aggregator to control critical tasks of the farm through a messaging service. The farm-monitoring module 207 applies a cognitive analysis engine that measures the engagement level of the farmer based on how often he or she follows up with tasks, takes additional effort to provide information for the system (e.g., leaves comments, takes a picture of a crop or farm, records video of the farm, etc.), etc.

The farm monitoring module 207d can also generate alerts useful to farmers to get better prices based on analyzing external events and may be used to detect and prevent defaults based on predicted market values of crops, weather changes, disease pattern, other “soft-data” (e.g., through M-PESA, M-shuari transaction history, etc.) of the farmer, etc.

Thus, the method 100 and the system 200 can estimate and/or generate farm activities, translate the activities on an electronic with tasks, and notify a user of the tasks on a farmer device (e.g., reminding tasks on a mobile device, smart watch, or in any configurable sensor). Also, events (e.g., weather, disease pattern, water sensor, market prices, etc.) can be tracked and analyzed to update tasks. Based on the analyzing and tracking of the events, in context, the electronic timetable is changed (e.g., updated), and may regenerate a notification automatically. Also, the electronic timetable for all farmers can be at the option of the farmer, accessible or visible to an aggregating agent (i.e., an agent who collects produces from more than one farmer). This may encourage aggregating agents to trust farmers and invest more.

That is, the method 100 and system 200 can dynamically estimate external events and resources of the farm (e.g., weather, crop yield, optimal harvest dates, etc.) and create a schedule on a calendar of tasks for farmers to optimally manage their crops. Thereby, even small-farms with limited resources can optimize their yields even when unpredictable events occur (e.g., events atypical to the Farmer's Almanac, harsh weather patterns, etc.).

### Exemplary Aspects, Using a Cloud Computing Environment

Although this detailed description includes an exemplary embodiment of the present invention in a cloud computing environment, it is to be understood that implementation of the teachings recited herein are not limited to such a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client circuits through a thin client interface such as a web browser (e.g., web-based e-mail) The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

Referring now to FIG. 3, a schematic of an example of a cloud computing node is shown. Cloud computing node 10 is only one example of a suitable node and is not intended to suggest any limitation as to the scope of use or functionality of embodiments of the invention described herein. Regardless, cloud computing node 10 is capable of being implemented and/or performing any of the functionality set forth herein.

Although cloud computing node 10 is depicted as a computer system/server 12, it is understood to be operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop circuits, multiprocessor systems, microprocessor-based systems, set top boxes, programmable consumer electronics, network PCs, minicomputer systems, mainframe computer systems, and distributed cloud computing environments that include any of the above systems or circuits, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing circuits that are linked through a communications network. In a distributed cloud computing environment, program modules may be located in both local and remote computer system storage media including memory storage circuits.

Referring again to FIG. 3, computer system/server 12 is shown in the form of a general-purpose computing circuit. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external circuits 14 such as a keyboard, a pointing circuit, a display 24, etc.; one or more circuits that enable a user to interact with computer system/server 12; and/or any circuits (e.g., network card, modem, etc.) that enable computer system/server 12 to communicate with one or more other computing circuits. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, circuit drivers, redundant processing units, external disk drive arrays, RAID systems, tape drives, and data archival storage systems, etc.

Referring now to FIG. 4, illustrative cloud computing environment 50 is depicted. As shown, cloud computing environment 50 comprises one or more cloud computing nodes 10 with which local computing circuits used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing circuit. It is understood that the types of computing circuits 54A-N shown in FIG. 4 are intended to be illustrative only and that computing nodes 10 and cloud computing environment 50 can communicate with any type of computerized circuit over any type of network and/or network addressable connection (e.g., using a web browser).

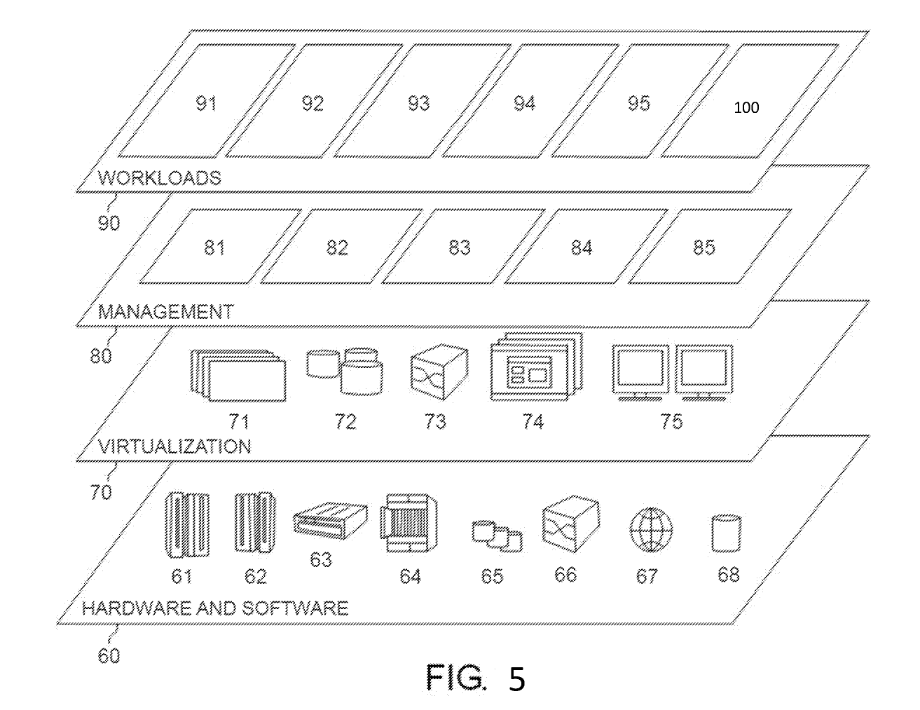

Referring now to FIG. 5, an exemplary set of functional abstraction layers provided by cloud computing environment 50 (FIG. 4) is shown. It should be understood in advance that the components, layers, and functions shown in FIG. 5 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage circuits 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and, more particularly relative to the present invention, the farm activity control method 100.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Further, Applicant's intent is to encompass the equivalents of all claim elements, and no amendment to any claim of the present application should be construed as a disclaimer of any interest in or right to an equivalent of any element or feature of the amended claim.

What is claimed is:

1. A computer-implemented farm activity control method, the method comprising:
generating a list of optimal farming activities including different phases of farming;
translating the list of optimal farming activates into a plurality of tasks that are sequenced in an order of operation or according to a time scale; and
generating a visual electronic calendar that displays and tracks a completion of the sequenced tasks while providing a notification based on a time and a criticality of each task.

2. The computer-implemented method of claim 1, further comprising updating and cascading the optimal farming activities, the tasks, the visual electronic calendar, and the notification based on sensed events from one or more plurality of sensors or a detected event performed by a user.

3. The computer-implemented method of claim 1, further comprising generating an aggregated farm view of the visual electronic calendar for an aggregator.

4. The computer-implemented method of claim 1, further comprising:
matching a benchmark of best practices for previously performed tasks by a user; and
generating further benchmarks based on an output of the activities and productivity of the user.

5. The computer-implemented method of claim 1, wherein the list of optimal farming activities is based on at least one of:
a model of crop growth; and
a statistical model of past farming activity and success rates of the past farming activity.

6. The computer-implemented method of claim 2, wherein the updating and cascading the optimal farming activities are determined by sensing, tracking and analyzing external events effect on the farming

7. The computer-implemented method of claim 3, wherein the generating the aggregated view includes estimating a crop yield, a value of the crop yield, and a probability of defaulting on a contract with an aggregator.

8. The computer-implemented method of claim 1, the wherein each optimal farm activity to be carried out by a farmer or farm aggregator is assigned a risk score determined by assessing the criticality of the activity and a cohort of the farmer or farm aggregator.

9. The computer-implemented method of claim 8, wherein the generated notifications cause an end user device to vibrate, blink, coloring, trigger voice command or trigger a other visual clue if the risk value is higher than a threshold.

10. A computer program product for farm activity control, the computer program product comprising a computer-readable storage medium having program instructions embodied therewith, the program instructions executable by a computer to cause the computer to perform:
generating a list of optimal farming activities including different phases of farming;
translating the list of optimal farming activates into a plurality of tasks that are sequenced in an order of operation or according to a time scale; and
generating a visual electronic calendar that displays and tracks a completion of the sequenced tasks while providing a notification based on a time and a criticality of each task.

11. The computer program product of claim 10, further comprising updating and cascading the optimal farming activities, the tasks, the visual electronic calendar, and the notification based on sensed events from one or more plurality of sensors or a detected event performed by a user.

12. The computer program product of claim 10, further comprising generating an aggregated farm view of the visual electronic calendar for an aggregator.

13. The computer program product of claim 10, further comprising:
matching a benchmark of best practices for previously performed tasks by a user; and
generating further benchmarks based on an output of the activities and productivity of the user.

14. The computer program product of claim 10, wherein the list of optimal farming activities is based on at least one of:
a model of crop growth; and
a statistical model of past farming activity and success rates of the past farming activity.

15. The computer program product of claim 11, wherein the updating and cascading activities are determined by sensing, tracking and analyzing external events' effect on the farming.

16. The computer program product of claim 12, wherein the generating the aggregated view includes estimating a crop yield, a value of the crop yield, and a probability of defaulting on a contract with an aggregator.

17. A farm activity control system, said system comprising:
a processor; and
a memory, the memory storing instructions to cause the processor to perform:
generating a list of optimal farming activities including different phases of farming;
translating the list of optimal farming activates into a plurality of tasks that are sequenced in an order of operation or according to a time scale; and
generating a visual electronic calendar that displays and tracks a completion of the sequenced tasks while providing a notification based on a time and a criticality of each task.

18. The system of claim 17, wherein the memory further stores instructions to cause the processor to perform:
updating and cascading the optimal farming activities, the tasks, the visual electronic calendar, and the notification based on a detected event performed by a user.

19. The system of claim 17, wherein the memory further stores instructions to cause the processor to perform:
generating an aggregated farm view of the visual electronic calendar for an aggregator.

20. The system of claim 16, embodied in a cloud-computing environment.
